(19) United States
(12) Patent Application Publication
(10) Pub. No.: US 2008/0055731 A1
(43) Pub. Date: Mar. 6, 2008

(54) AIRPLANE WINDOW CONTROL

(75) Inventors: Anthony W. Boston, Lake Stevens, WA (US); Steven A. St. Onge, Mill Creek, WA (US); Chris Samhammer, Redmond, WA (US); Chongman Whang, Lynnwood, WA (US); Todd F. Adams, Shoreline, WA (US); Edward G. Nielsen, Bothell, WA (US); James M. Malek, Snohomish, WA (US)

Correspondence Address: OSTRAGER CHONG FLAHERTY & BROITMAN, P.C., 570 LEXINGTON AVENUE, FLOOR 17, NEW YORK, NY, 10022-6894, US

(73) Assignee: THE BOEING COMPANY, Seal Beach, CA (US)

(21) Appl. No.: 11/828,861

(22) Filed: Jul. 26, 2007

Related U.S. Application Data
(60) Provisional application No. 60/824,282, filed on Aug. 31, 2006.

(51) Int. Cl. G02F 1/17; E06B 9/24

(52) U.S. Cl. 359/614

(57) ABSTRACT

An electrically dimmable window (“EDW”) system comprising an EDW, a control switch, and a controller. The switch and controller control the light transmittance level of the EDW. State indicators indicate when the EDW is in transition from one light transmittance level to another level. When there is no transition in light transmittance level, the indicators may denote the current light transmittance level of the EDW.

### PRIORITY CLAIM AND CROSS REFERENCE TO RELATED APPLICATIONS

This non-provisional patent application claims priority from U.S. Provisional Application No. 60/824,282, filed on Aug. 31, 2006, which, in turn, is a continuation-in-part of prior U.S. application Ser. No. 29/247,626, filed Jun. 29, 2006. Both U.S. Provisional Application No. 60/824,282 and U.S. application Ser. No. 29/247,626 are incorporated herein by reference.

### TECHNICAL FIELD

The disclosure relates to a control for a vehicle window that will allow passengers to electronically shade their windows.

### BACKGROUND

Mechanical shades are presently used on airplane windows. The shades can be opened to allow passengers to see the view outside. However, opening a shade, even partially, can let in a lot of light, which can be very distracting to passengers or other people on board who want to, for example, relax, take a nap, or watch a movie. Further, a passenger is unable to view out the window when the shade is substantially closed.

A device, and/or method of use, is needed to decrease one or more problems with one or more of the existing devices and/or methods for controlling the shading of vehicle windows.

### SUMMARY

The present disclosure is directed to a system and methods for electronically controlling the amount of light that goes through a vehicle window, such as, for example, an airplane window. The embodiments of the disclosure will allow a passenger to darken a window, or to lighten a window enough to see outside without disturbing passengers when the cabin is darkened for sleep or entertainment. Thus, a passenger will be able to enjoy the view outside the window because the present disclosure allows a passenger to sufficiently “undim” a window to see outside.

The disclosed window system comprises an electrically dimmable window (“EDW”), a control switch, and a controller. The control switch may ideally be located in close vicinity to EDW. The switch controls the visible light transmittance (“VLT”) level of the EDW, and the controller communicates and interfaces with the EDW. State or status indicators may flash when the EDW is in transition from one VLT level to another level. When there is no transition in VLT level, the indicators may continuously denote the current VLT level of the EDW.

Methods for operating the window system are also disclosed. In one disclosed method, when the control switch is pressed, the EDW's current VLT level is displayed by lighting one of the LED state indicators. The LED state indicators may be turned off or cleared after a certain time period if the control switch is not pressed. In one embodiment, the time period is 1.5 seconds, but other time periods may be used. However, if the control switch is pressed, the VLT level is appropriately changed and the LED state indicators flash at a given interval during the transition of the VLT level. In one embodiment of the disclosure, the flash interval is one flash per second; however, other flash intervals may be used. Once the transition to a VLT level is completed, the LED state indicators are turned off or cleared.

In another disclosed method for controlling an EDW having only two possible VLT levels, when the control switch is pressed, the EDW switches from one level to the other level. Thus, if the EDW was transparent (first level) when the control switch was pressed, the VLT level will transition to opaque (second level). During the transition, LED state indicators may flash at a specified interval such as one flash per second, as shown in one embodiment. If the user continuously presses the control switch for a particular time period, such as five seconds or more, the VLT level will return to the transparent or cleared state. However, if the VLT level is opaque, pressing the control switch will change the VLT level to transparent.

### BRIEF DESCRIPTION OF THE DRAWINGS

The foregoing aspects and many of the attendant advantages of embodiments of this disclosure will become more readily appreciated by reference to the following detailed description, when taken in conjunction with the accompanying drawings, wherein:

FIG. 1 depicts a general overview of a passenger seat EDW system of the disclosure;

FIG. 1A depicts the location of a controller for an EDW system in a lower reveal of a window;

FIG. 2 shows an embodiment of an EDW system of the disclosure;

FIG. 3 shows a switch in an embodiment of an EDW system of the disclosure;

FIG. 4 shows a flowchart of a method of adjusting a light transmittance of an EDW of the disclosure;

FIG. 5 shows a state transition diagram depicting a logical operation of passenger EDW control switch in accordance with the disclosure; and

FIG. 6 shows a state transition diagram depicting a logical operation of door EDW control switch in accordance with the disclosure.

### DETAILED DESCRIPTION

An EDW is an electrical device that absorbs a range of wavelength in the visible light spectrum when an electrical potential is applied. The present disclosure utilizes EDW to replace existing mechanical shades for airplane windows to provide more comfort to passengers and more control and easier operation to cabin crews. EDWs also can be used, without limitation, for lavatory doors, exit doors, and whatever partitions may be in the aircraft. In service, EDWs comply with all applicable existing Federal Aviation Administration and European Aviation Safety Agency requirements. In one embodiment, an EDW assumes an original defined transparent state such as during a power outage, takeoff, landing, and/or an emergency situation (such as an emergency evacuation, for example), or whenever necessary.

### Passenger Seat EDW

A passenger seat EDW provides more comfort to passengers because they can change the VLT level to accommodate their needs. In one embodiment, there are five VLT levels: opaque, transparent, and three intermediate settings between opaque and transparent. Of course, other embodiments may have up to an infinite number of VLT levels between opaque and transparent without departing from the spirit of the disclosure.

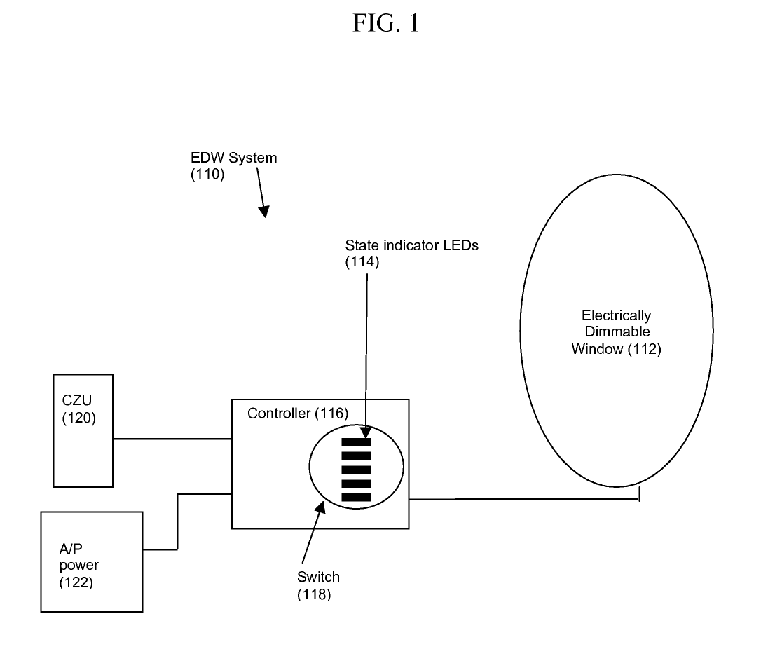

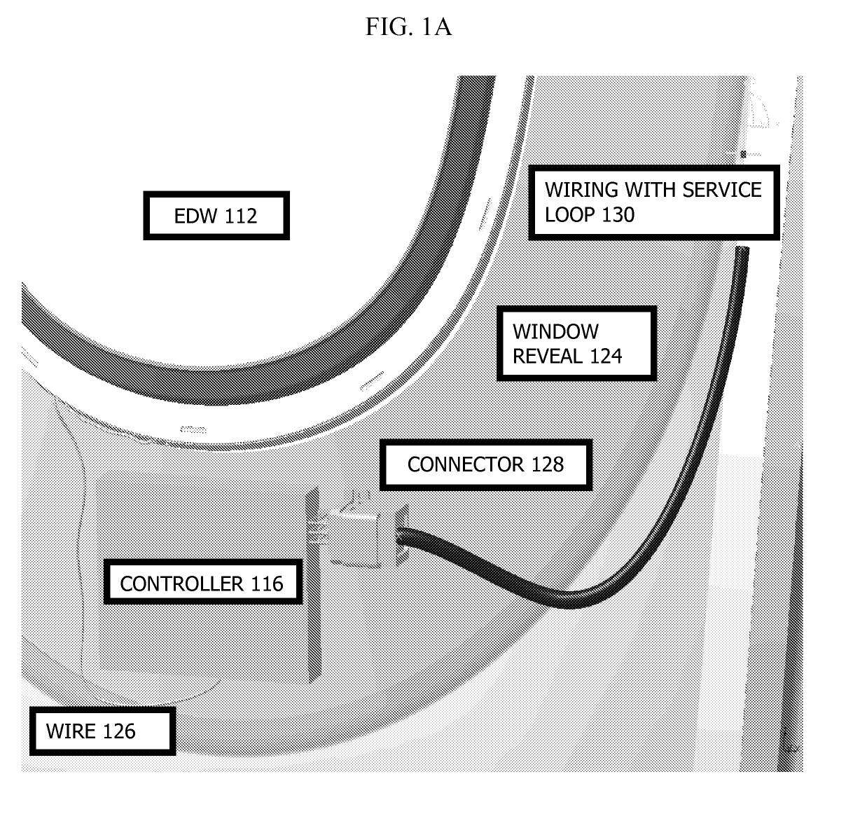

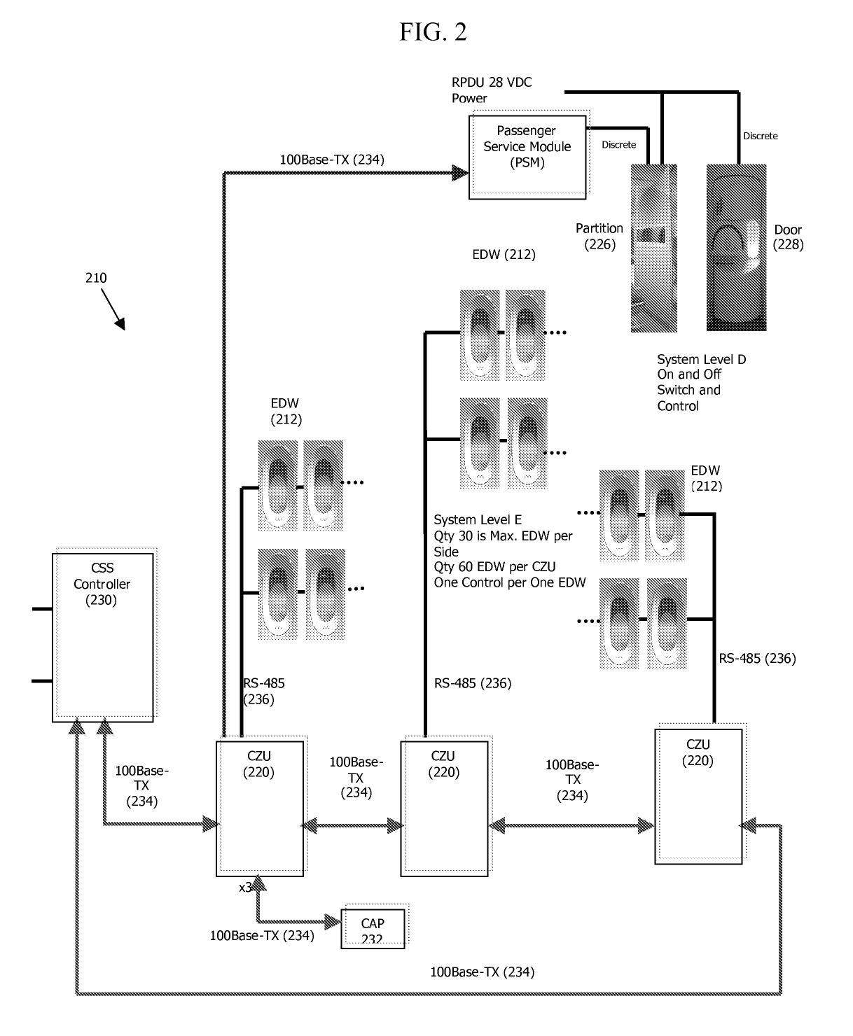

FIG. 1 depicts a general overview of a passenger seat EDW System 110, which comprises an EDW 112, a controller 116, and EDW control switch 118. The EDW control switch 118 ideally is located in close vicinity to EDW 112. The switch 118 controls the VLT level of EDW 112, and the controller 116 communicates and interfaces with cabin zone unit (“CZU”) 120 and EDW 112. The controller 116, which comprises switch 118, comprises LED state indicators 114 that flash when EDW 112 is in transition from one VLT level to another level. When there is no transition in VLT level, the LED state indicators 114 remain continuously lit to denote the current VLT level of EDW 112. Controller 116 can also communicate and interface with the cabin service system (“CSS”) (discussed in FIG. 2) and to EDW 112.

FIG. 1A depicts the relative location of a controller 116 in one embodiment of an EDW system of the disclosure. FIG. 1A shows a controller 116 connected to an EDW 112 via a wire 126. The controller 116, in turn, is connected to a service loop 130 via a connector 128. As shown in FIG. 1A, controller 116, which contains EDW control switch 118 (not shown in FIG. 1A), is located in a lower portion of window reveal 124.

FIG. 2 shows an embodiment of an EDW System 210 comprising several EDW units 212 in communication with several CZU units 220 controlled by CSS controller 230 connected over an Ethernet network 234, only a portion of which is shown. In the embodiment shown in FIG. 2, the network is running at speeds of up to 100 Mbps, as indicated by the 100 Base-TX connections, which is known in the art. CSS, as known in the art, provide control systems that allow, inter alia, passenger address announcements, cabin interphone system and cabin to cockpit crew communications, passenger services system for attendant call, lavatory availability, and seat controls, and cabin lighting. The disclosure makes use of CSS to likewise control EDW units. CZUs are components of CSS, providing crew-operated controls for CSS systems. In one implementation, CZUs provides such controls at three separate data hub control stations (not shown), one each in three main cabin zones (not shown), located between main airplane doors 1 and 2, 2 and 3, and 3 and 4 (not shown). In the embodiment shown in FIG. 2, CZU 220 communicates with EDW 212 via RS-485 serial interface 236.

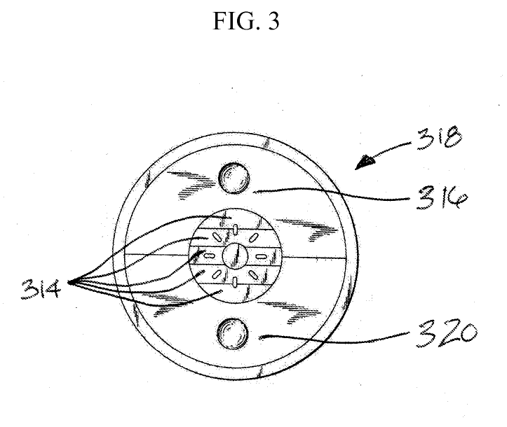

In FIG. 3 an embodiment of an EDW control switch in accordance with the disclosure is shown. EDW control switch 318 is an up/down-step type switch comprising an up-step switch portion 316, a down-step switch portion 320 and LED state indicators 314. In the embodiment shown, there are five LED state indicators 314; however, either more or less than five LED state indicators may be used depending on design choice without departing from the spirit of the disclosure.

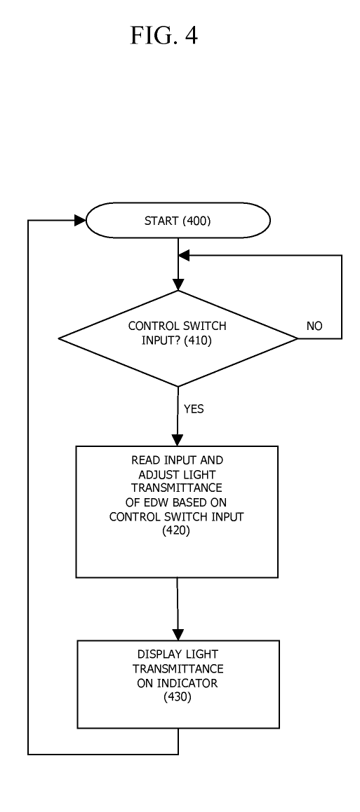

FIG. 4 depicts a flowchart of a method for controlling an electrically dimmable window. In step 410, a determination is made whether or not there is any input from EDW control switch 118. If there is no input, the flowchart loops back to step 410 until an input appears on EDW control switch 118. Once there is an input from control switch 118, the input is read in step 420 and then the VLT level of EDW 112 is adjusted based on the input from EDW control switch 118. Thus, if the input from control switch 118 is for a lower VLT level, then the VLT level is lowered; if the input from control switch 118 is for a higher VLT level, then the VLT level is increased. The subsequent VLT level may then be displayed on state indicators 114.

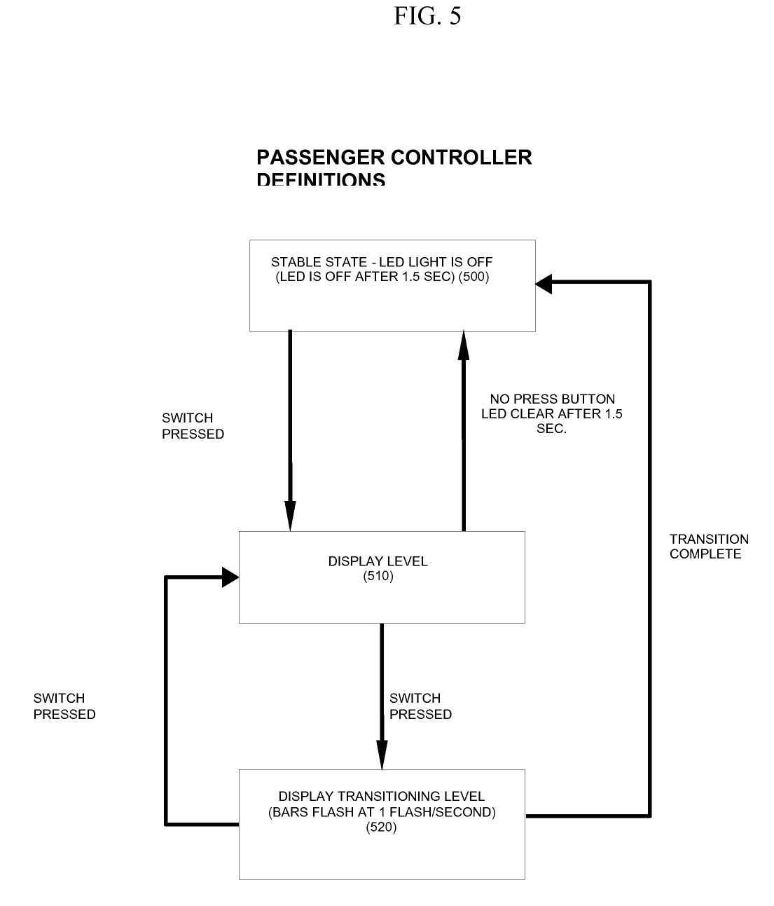

FIG. 5 shows a state transition diagram depicting a logical operation of EDW control switch 318 for use in conjunction with, for example, passenger widow 112 in FIG. 1 or window 212 in FIG. 2. In stable state 500, LED state indicators 314 are off. When either up-step switch portion 316 or down-step switch portion 320 is pressed, the current VLT level on the relevant EDW is displayed in step 510 by lighting one of the LED state indicators 314. Other display means, such as a video monitor (not shown), may be used without departing from the spirit of the disclosure.

The LED state indicators 314 may be turned off or cleared after a certain time period if the EDW control switch 318 (either up-step switch portion 316 or down-step switch portion 320) is not pressed and control goes back to stable state 500. In one embodiment, the time period is 1.5 seconds as indicated in FIG. 5, but other time periods may be used without departing from the spirit of the disclosure.

However, if the EDW control switch 318 (either up-step switch portion 316 or down-step switch portion 320) is pressed, the VLT level is appropriately changed in state 520 and the LED state indicators 314 flash at a given interval. As shown in FIG. 5, in one embodiment of the disclosure, the flash interval is one flash per second; however, other flash intervals may be used without departing from the spirit of the disclosure. Once the transition to a VLT level is completed, the LED state indicators 314 are turned off or cleared and the system returns to stable state 500.

FIG. 2 also depicts the use of an EDW in a partition 226 and/or in a aircraft door 228. Although not shown in FIG. 2, the EDW System 210 may also be implemented in lavatories. All the function and system work the same way as described above; however, different embodiments may be implemented because of safety considerations, examples of which are described below.

### Door EDW

With respect to aircraft door 228 shown in FIG. 2, emergency exit doors are typically designed with an outside viewing window that allows flight crews and/or passengers to quickly assess outside conditions before deciding to open such emergency exit doors in an emergency situation. As with the passenger windows, the door windows may also be equipped with EDW in lieu of a mechanical shade.

It must be kept in mind, however, that EDW installed on exit or emergency doors should not cause an unacceptable delay in a flight attendant's ability to quickly assess conditions outside the door. Thus, although door EDWs use the same technology as the other EDWs installed in the cabin (e.g., passenger windows and partitions), it is preferred that each EDW system installed on a door is completely independent of the other EDWs installed in the cabin. As shown in FIG. 2, the door EDW does not have interface to CSS controller 230. For safety reasons, main cabin door EDWs must be able to be operated independent of CSS so that a CSS failure has no impact on the main cabin entry/exit EDWs, which typically comprise eight doors. In the event an evacuation becomes necessary, each door EDW must be independently operable in order for a crew member to have a clear view outside the door EDW.

Although not shown, like in the passenger EDW system described in FIG. 1, the EDW control switch may be located near the door window. In one embodiment, the EDW control switch will allow the door window to change between two states: opaque and transparent. When the door window is in the opaque state, the EDW control switch will illuminate and be viewable by a user such as, for example, a seated flight attendant, under all interior lighting conditions. When the door window is in the transparent state, the EDW control switch will not be illuminated.

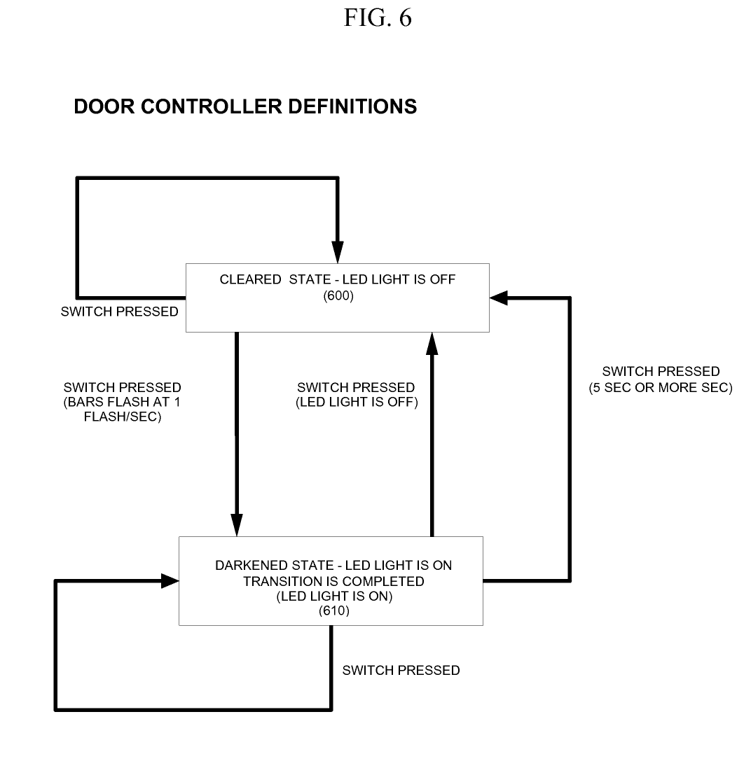

FIG. 6 shows a state transition diagram depicting a logical operation of EDW control switch 318 for use in conjunction with a door EDW. In cleared state 600, LED state indicators 314 are off. When either up-step switch portion 316 or down-step switch portion 320 is pressed, the door EDW switches from one state to the other. Thus, assuming that the door EDW is transparent when in the cleared state 600, pressing control switch 318 will change the VLT level to opaque and transition to and remain in darkened state 610. During the transition, LED state indicators 314 may flash at a specified interval such as one flash per second as shown in the embodiment depicted in FIG. 6. If the user continuously presses control switch 318 for a particular time period, such as five seconds or more in the embodiment depicted in FIG. 6, the VLT level will return to the transparent or cleared state 600.

However, if the VLT level is opaque, such that the EDW control switch 318 is in darkened state 610, pressing EDW control switch 318 (i.e., either up-step switch portion 316 or down-step switch portion 320) will change the VLT level to transparent and EDW control switch 318 will remain in cleared state 600.

For safety reasons, the un-powered operational mode of the door EDW is the transparent state. Thus, in the event of the loss of power or system failure, the door window will default to the transparent state. Also, aside from the loss of airplane power, there is no single failure, such as a CSS failure as previously described, that can affect more than one door EDW 228.

Even if a door EDW 228 is in an opaque state, the door EDW 228 will allow recognition of an external fire. In one embodiment, the door EDWs 228 at the opaque state will allow more VLT than a passenger seat EDW (such as, for example, 112 or 212) at the most opaque state—in other words, door EDWs 228 will not be allowed to get as dark as the passenger windows 112 or 212. In one embodiment, the opaque or darkest level for either EDW 112 or EDW 228 will allow recognition of an external fire.

In another embodiment, the door EDWs 228 will always be in the transparent state whenever an emergency evacuation could be declared. The illuminated EDW control switch (not shown) provides an additional means to allow the flight attendant to verify the status of the door windows 228. However, even if a door window 228 was inadvertently left in the opaque state when an emergency evacuation was declared, the window 228 would provide enough visible light transfer to allow recognition of an external fire, as previously stated. In addition, the door EDWs 228 will automatically transition to the clear state when the normal airplane power is shut off (shutting off the normal airplane power is part of the flight crew procedures when an emergency evacuation is declared). This automatic clearing will also assist ground rescue personnel in assessing conditions inside the airplane.

### Lavatory EDW

Lavatories may also include EDWs that may be completely dark or opaque when a lavatory is occupied, which may be triggered, for example, by a user locking the door of the lavatory. Once the user unlocks the door, the EDW 112 will revert to its original transparent state, in a way similar to the function of a partition EDW 226 discussed below.

### Partition EDW

EDWs may also be used in cabin partitions such as 226 in FIG. 2, which, as previously described, may operate in an opaque state and a transparent state. In one embodiment, cabin crews have total control over VLT levels for partition EDWs 226 through cabin attendant panel, discussed below. Partition EDWs 226 can be implemented to be in an original transparent state to enable cabin crew members to see seated passenger and the cabin. Partition EDWs 226 work the same way as, e.g., EDWs 112 and 228, except that partition EDW 226 may have a backup mechanical switch to control the EDW 226 manually.

In another embodiment, however, partition EDW 226 may operate in a manner similar to the operation of EDW 112 or 212 described above. In other words, rather than operating only in an opaque or transparent VLT level, EDW 226 may have up to an infinite number of VLT levels between opaque and transparent without departing from the spirit of the disclosure.

### Cabin Attendant Panel

In one embodiment, cabin crew members will have primary control over the VLT levels with the ability to transfer some control to the passengers as appropriate by use of a cabin attendant panel (“CAP”) 232, shown in FIG. 2. Using the CAP 232, cabin crews will have primary control over the allowed VLT level for windows within a particular zone such as, for example, first class zone, business class zone, coach zone, all left windows, all right windows, all windows, or any combination thereof, and will have the ability to transfer some control to the passengers as cabin crew members deem appropriate.

Normal airplane power is used for all EDWs. If the airplane transitions from normal power to emergency power, the EDWs will automatically transition to the transparent state. In the event of switch failure, cabin service system has full control that the window can go to originally defined transparent state if it is necessary. When there is a loss of communication between cabin service system and controller or CSS failure, a passenger has full control over VLT level that it can go to originally defined transparent state if it is necessary. In one embodiment, a loss of communication status in connection with passenger window EDW function is in effect if no messages are received from the CSS for a period of at least 2 minutes.

Although the embodiments of the disclosure have been illustrated and described with specific embodiments for use in an aircraft, it will be appreciated that the embodiments can be used in other vehicles including without limitation buses, boats, trains, and cars and that various changes can be made therein without departing from the spirit and scope of the disclosure. Within the scope of the appended claims, it is to be understood that the embodiments of the disclosure can be practiced otherwise than as specifically described herein.

What is claimed is:

1. A window system comprising:
an electrically dimmable window;
a control switch; and
a controller for changing the light transmittance of the electrically dimmable window based on an input received from the control switch.

2. The system of claim 1 further comprising an indicator to indicate a light transmittance level of the electrically dimmable window.

3. The system of claim 2 wherein the controller changes a state of the indicator based on the input received from the control switch.

4. The system of claim 1 wherein the light transmittance of the electrically dimmable window is one of opaque and transparent.

5. The system of claim 4, wherein the light transmittance of the electrically dimmable window further comprises at least one intermediate level between opaque and transparent.

6. The system of claim 3, wherein the state of the indicator depicts that the light transmittance level is in transition from one level to another.

7. The system of claim 2, wherein the indicator comprises at least one light emitting diode.

8. The system of claim 2, wherein the indicator comprises a video monitor.

9. The system of claim 6, wherein the indicator flashes when the light transmittance of the electrically dimmable window is in transition from one level to another level.

10. The system of claim 9, wherein the indicator flashes at a rate of one flash a second.

11. The system of claim 4, wherein the light transmittance of the electrically dimmable window is transparent in an emergency situation.

12. The system of claim 4, wherein the light transmittance of the electrically dimmable window is transparent in case of a system failure.

13. The system of claim 2, wherein the indicator is turned off when no input is received from the control switch after a time interval.

14. The system of claim 13, wherein the time interval is 1.5 seconds.

15. The system of claim 1 for use in a vehicle.

16. The system of claim 15 for use in an aircraft.

17. A method for controlling an electrically dimmable window comprising:
reading an input from a control switch for the electrically dimmable window; and
if the input from the control switch exists, adjusting a light transmittance of the electrically dimmable window based on the input from the control switch.

18. The method of claim 17 further comprising displaying the light transmittance on an indicator.

19. The method of claim 17, further comprising indicating that adjusting the light transmittance of the electrically dimmable window is taking place.

20. The method of claim 19, further comprising terminating the indicating step once the adjusting step is completed.

21. The method of claim 19, wherein the indicating step comprises flashing an indicator light on the control switch.

22. The method of claim 21, wherein the indicator light is a light emitting diode.

23. The method of claim 17, wherein the adjusting the light transmittance is increasing the light transmittance.

24. The method of claim 17, wherein the adjusting the light transmittance is decreasing the light transmittance.

25. The method of claim 17, wherein if an emergency situation is detected, further comprising adjusting the light transmittance of the electrically dimmable window to a transparent level.

26. The method of claim 17, wherein if a failure in the control switch is detected, further comprising adjusting the light transmittance of the electrically dimmable window to a transparent level.

27. The method of claim 17 for use in a vehicle.

28. The method of claim 27 for use in an aircraft.

29. A method for controlling an electrically dimmable window having only a first light transmittance level and a second light transmittance level, the method comprising:
reading an input from a control switch for the electrically dimmable window, wherein the control switch comprises an indicator to indicate a light transmittance of the electrically dimmable window;
if the input from the control switch exists, adjusting the light transmittance of the electrically dimmable window from the first light transmittance level to the second light transmittance level; and
indicating the light transmittance on the indicator.

30. The method of claim 29, wherein the first light transmittance level is opaque.

31. The method of claim 29, wherein the first light transmittance level is transparent.

32. The method of claim 29, further comprising flashing the indicator while the adjusting step is taking place.

33. The method of claim 29, wherein if the input from the control switch remains continuous for greater than a threshold time, further comprising adjusting the light transmittance to a transparent level.

34. The method of claim 33, wherein the threshold time is five seconds.

35. The method of claim 29, wherein if an emergency situation is detected, further comprising adjusting the light transmittance of the electrically dimmable window to a transparent level.

36. The method of claim 29, wherein if a failure in the control switch is detected, further comprising adjusting the light transmittance of the electrically dimmable window to a transparent level.

37. The method of claim 29 for use in a vehicle.

38. The method of claim 37 for use in an aircraft.
